(19) United States
(12) Patent Application Publication
(10) Pub. No.: US 2021/0359576 A1
(43) Pub. Date: Nov. 18, 2021

(54) WATER CHAMBER COVER FOR A WATER COOLING SYSTEM OF AN ELECTRIC MACHINE

(71) Applicant: SIEMENS AKTIENGESELLSCHAFT, Munich (DE)

(72) Inventors: Andrey MASHKIN, Köln (DE); Mario BROCKSCHMIDT, Essen (DE); Christoph LEHMANN, Neukirchen-Vluyn (DE); Daniel HANSMANN, Herten (DE); Rene HÖHNER, Gelsenkirchen (DE); Ralf MERTE, Dortmund (DE); Friedhelm POHLMANN, Essen (DE); Markus WYSGOL, Bochum (DE)

(73) Assignee: Siemens Aktiengesellschaft, Munich (DE)

(21) Appl. No.: 16/325,811

(22) PCT Filed: Jul. 13, 2017
(86) PCT No.: PCT/EP2017/067688

§ 371 Date: Feb. 15, 2019

(30) Foreign Application Priority Data
Aug. 19, 2016 (EP) 16184842.9

(51) Int. Cl. H02K 9/197; H02K 7/18

(52) U.S. Cl. CPC H02K 9/197; H02K 7/1823

(57) ABSTRACT

A water chamber cover for connecting a water hose to a water chamber bottom plate of a directly water-cooled stator bar, having a peripheral groove, which is open on a side facing away from the water chamber and which is designed to hold the water hose. A method is for assembling a cooling water circuit for a directly water-cooled stator bar.

### CROSS REFERENCE TO RELATED APPLICATIONS

This application is the US National Stage of International Application No. PCT/EP2017/067688 filed Jul. 13, 2017, and claims the benefit thereof. The International Application claims the benefit of European Application No. EP16184842 filed Aug. 19, 2016. All of the applications are incorporated by reference herein in their entirety.

### FIELD OF INVENTION

The invention relates to a water chamber cover for connecting a water hose to a water chamber bottom plate of a directly water-cooled stator bar in an electric machine, and to a cooling circuit connection fitting with such a water chamber cover, and to a method for assembling a cooling circuit for a directly water-cooled stator bar.

### BACKGROUND OF INVENTION

In known turbogenerators and other electric machines, the turbogenerator stator windings are frequently cooled in a manner known per se by means of direct water cooling, wherein the cooling water is circulated in the stator bars with the aid of cooling ducts in which deionized water flows. Known water cooling systems consist, for example, of water collecting rings on the generator housing, water chambers at the bar ends and water cooling ducts in the bars. However, the current path in the stator windings does not run via the water or cooling ducts, but rather via solid copper along the bars.

For example, stainless steel cooling ducts are used in a known directly water-cooled stator winding bar. The stator winding bars with such stainless steel cooling ducts have, at a bar end, water chambers made of steel which are welded onto the steel cooling ducts.

The water chamber essentially consists here of a water chamber bottom plate and a water chamber cover, wherein the cooling ducts are welded to the bottom plate at recesses thereof in a water-tight manner. The stator bars with stainless steel cooling ducts therefore have no water-copper contact whatsoever and do not contaminate the cooling water. In order to be able to distribute the cooling water uniformly to the individual cooling ducts, just the water chamber is provided which is bounded in a water-tight manner by the water chamber bottom plate and a water chamber cover welded thereto, wherein the water chamber cover has a screw connection for a water hose.

However, the assembly of the described, known cooling circuit has proven difficult because the water chamber has to be awkwardly welded or brazed onto the stator bar and, subsequently, the water hose has to be just as awkwardly screwed onto the water chamber cover in the actual installation environment.

### SUMMARY OF INVENTION

It is therefore an object of the invention to specify a water chamber cover which permits simpler assembly of the cooling circuit for a directly water-cooled stator bar.

According to a first aspect of the invention, a water chamber cover for connecting a water hose to a water chamber bottom plate of a directly water-cooled stator bar is proposed, comprising a peripheral groove which is open on a side facing away from the water chamber and is designed to hold the water hose.

Alternatively, the peripheral groove for holding the water hose is formed in a separate element connected to the water chamber cover, or the water chamber cover is formed together with the water hose.

According to a second aspect of the invention, a cooling circuit connection fitting with at least one water hose and a water chamber cover is proposed within the context of the invention.

According to a third aspect of the invention, a method for assembling a cooling water circuit for a directly water-cooled stator bar is indicated, wherein a water hose is inserted between an outer wall and an inner wall of a peripheral groove of a water chamber cover, and the outer wall is pressed radially inward against the water hose and/or the inner wall in a water-tight manner.

Such a configuration of the water chamber cover makes it possible, for example, to connect a water chamber cover already fitted to the water chamber at the installation site of the stator bar to the water hose in a significantly simpler manner by the awkward screwing-on operation being able to be replaced by plugging on the water hose at the peripheral groove. A diameter of the peripheral groove and a diameter of the water hose can be coordinated with each other and/or tolerated with respect to each other in such a manner that a reliably water-tight press fit arises when the hose is pushed onto the groove or is pushed into the groove.

Such an assembly operation can be carried out, for example, by use of a suitable lever tool. If necessary, the peripheral groove and the water hose can additionally be pressed against each other.

Alternatively, a method for assembling a cooling circuit is indicated, wherein a water hose fitting consisting of water chamber cover and water hose is first of all produced and is advantageously subsequently connected to the remaining components (e.g. water collecting pipe) of the water cooling system, and only at the installation site is connected by means of a water-tight connection of the water chamber cover to the water chamber bottom plate of the cooling circuit.

The peripheral groove advantageously has an inner wall and an outer wall, wherein the outer wall is designed to be pressed radially inward against the hose and the inner wall in a water-tight manner. For this purpose, for example, at least that region of the water chamber cover in which the peripheral groove is arranged can be formed from a suitably ductile metal material in a suitable wall thickness of the outer wall. The inner wall is advantageously provided with a greater wall thickness than the outer wall in order, when a pressing tool is used against the outer wall, to be able to press the latter against the hose and against the inner wall without the inner wall yielding.

According to a development, the water chamber cover has a cover body and a water hose connector, wherein the latter is connected to the cover body in a form-fitting and water-tight manner, and/or wherein the peripheral groove is arranged on the water hose connector. Such a design of the water chamber cover with separate components which are advantageously connected by means of a screw-connection with an O ring seal, by means of a heat shrinkage connection or by means of brazing makes it possible to use different materials, e.g. polymers and metals, for the cover body of the water chamber cover and the water hose connector. This may be desirable, for example, for cost reasons.

In order to permit joint assembly of the water chamber cover with a water hose already connected, the water chamber cover, according to an embodiment, has at least one bottom plate connecting element which is designed to be connected in a fitted state to the water chamber bottom plate in a form-fitting manner. In particular if the form-fitting connection is not water-tight by itself, the water chamber cover can have a sealing element which is arranged on a contact surface of the water chamber cover and is designed, in a fitted state, to seal a bottom chamber connecting periphery of the water chamber cover and of the water chamber bottom plate against water escaping.

Both the connection between the water hose connector and the cover body and the connection between the cover body and the water chamber bottom plate can be formed irrespective of the type of the other connection in each case, for example by one of the following types of connection: by a screw connection, by a heat shrinkage connection or by brazing.

These types of connection have different advantages. For example, brazing can be formed in a manner which is already water-tight per se, as can also a heat shrinkage connection. With a heat shrinkage connection, relatively simple assembly can be achieved. Screw connections can be used relatively favorably. In the event of a screw connection, the use of a plurality of screws is advantageously provided, the screws, in the fitted state, extending through screw holes of the water chamber cover toward an internal thread of the water chamber bottom plate by said screws being able to be screwed in and then, with their screwhead, being able to hold the water chamber cover.

A screw connection can also be brought about by a union nut which is pulled over the water chamber cover and is screwed onto a round bottom plate.

According to an embodiment, when the water hose is assembled in the peripheral groove, the water hose is inserted into the groove as far as a groove stop, in particular in order to ensure a consistent connection quality, whether, for example, by means of a press fit or by pressing an outer wall of the peripheral groove.

Before the assembly of the water hose, in an embodiment a water hose connector and a cover body of the water chamber cover are connected to each other in a form-fitting and water-tight manner.

In a further embodiment, after assembly of the water hose in the peripheral groove, the cooling circuit connection fitting formed with the water chamber cover and the hose is connected to a water chamber bottom plate (which then contains an internal thread for receiving the screws) in a form-fitting and water-tight manner by means of a bottom plate connecting element (advantageously of a plurality of screws). For this purpose, use can be made of an O ring or another suitable seal.

### BRIEF DESCRIPTION OF THE DRAWINGS

The above-described properties, features and advantages of this invention and the manner in which they are achieved will become clearer and more clearly understood together with the description below of the exemplary embodiments which will be explained in more detail in conjunction with the drawings, wherein:

FIG. 1 shows a directly water-cooled stator bar with a water chamber cover according to one embodiment of the invention in a sectional view; and

FIG. 2 shows a directly water-cooled stator bar with a water chamber cover according to a further embodiment of the invention in a sectional view.

### DETAILED DESCRIPTION OF INVENTION

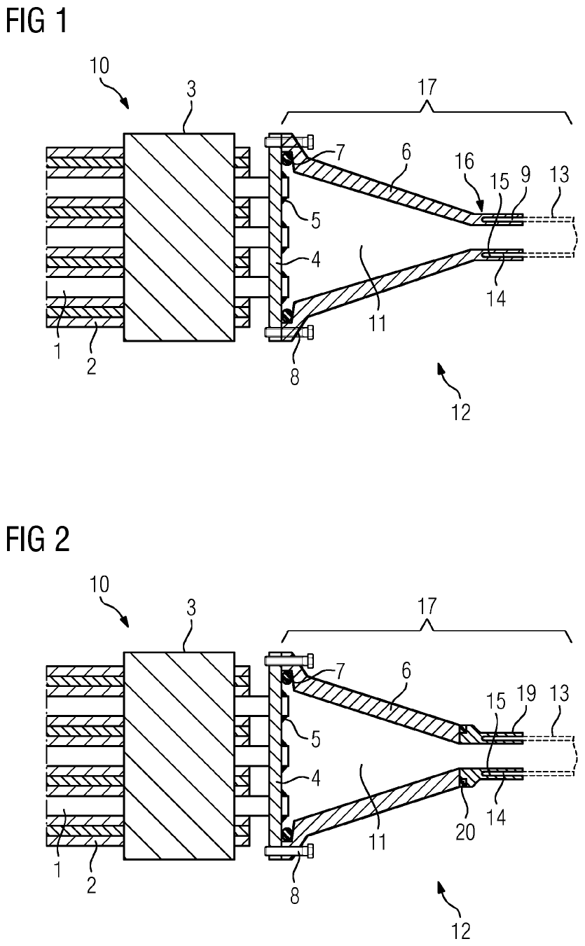

FIG. 1 illustrates a water-cooled stator bar 10 of a turbogenerator with steel cooling ducts 1 and copper conductor elements 2 at an axial end of the stator bar 10, at which the latter is electrically connected by means of a copper conductor block 3 and can be connected to a cooling water circuit of the turbogenerator by means of a water chamber bottom plate 4.

The individual steel cooling ducts 1 are fastened to the water chamber bottom plate 4 by means of encircling weld seams 5 of water-tight design. A water chamber 11 for connecting the stator bar 10 to the cooling water circuit is formed on that side of the water chamber bottom plate 4 which faces away from the stator bar 10.

The water chamber 11 is formed by the water chamber bottom plate 4 and the water chamber cover 12, which is screwed to the water chamber bottom plate 4 by four bottom plate connecting elements 8 in the form of screws. The contact pressure force, imparted by means of the screws 8, between the water chamber cover 12 and the water chamber bottom plate 4 permits sealing of the water chamber 11 against an escape of water by means of a sealing element 7 formed as an encircling O ring.

The water chamber cover 12 has a cover body 6 for sealing the water chamber 11 in relation to an escape of water and a peripheral groove 9 which is designed to receive a water hose 13, illustrated by dashed lines in FIG. 1. The water hose is designed in turn specifically to supply the water chamber 11 and therefore also the cooling circuit with the steel cooling ducts 1 with cooling water.

The peripheral groove 9 has an inner wall 14 and an outer wall 15, wherein the outer wall 15 is designed to be pressed radially inward against the hose 13 and against the inner wall 14 in a water-tight manner. In addition, in this exemplary embodiment, a stop 16 is provided, up to which the water hose 13 is pushed during the assembly on the water chamber cover 12.

It will now be illustrated below how a cooling water circuit within the context of the invention can be fitted simply and favorably in terms of time and costs, and how this is delimited over embodiments according to the prior art.

In known water-cooled stator bars which are connected to a cooling water circuit by means of a water chamber, during a preassembly step the stator bar together with the welded water chamber is already placed in the turbogenerator. A conventional water hose has, at its end on the water-chamber side, a screw nut which has to be screwed onto a thread of the conventional water chamber cover by means of a suitable tool at a location which can be unfavorable to reach. This is a time-consuming and error-prone process which is worth avoiding.

The water chamber cover 12 according to the embodiment described here permits a different assembly: in a first step, the water hose 13 is pushed into the water chamber cover 12, which is not yet arranged on the stator bar 10, as far as the stop 16 between the inner wall 14 and the outer wall 15 of the peripheral groove 9. Subsequently, at a freely selectable assembly location, the outer wall 15 is pressed against the hose 13 and the inner wall 14 by a suitable tool.

The cooling circuit fitting 17 which is thus preassembled can be subsequently guided to the preassembled stator bar 10 and placed onto the water chamber bottom plate 4. With suitable positioning of the sealing element 7, a water-tight connection can be produced there by screwing in by means of the screws 8, with the water-tight water chamber 11 being produced. Such an assembly is significantly less error-prone than the known assembly described at the beginning.

FIG. 2 illustrates an embodiment which differs from that according to FIG. 1 in particular in that the water chamber cover 12 in addition to the cover body 6 has a separate water hose connector 19 which, for example, is suitably shrink-fitted to the cover body, wherein, in the embodiment described here, an additional sealing element 20 ensures the water-tight design.

Such a configuration can afford the advantage, for example, that the cover body 6 can be produced from a relatively favorable material, for example from a plastic, whereas only the relatively small water hose connector 19 has to be produced from a more expensive material—for example a compressible metal material.

Otherwise, essentially the same advantages with conventional cooling water circuits as described with regard to FIG. 1 arise from a water chamber cover 12 according to FIG. 2.

1. A water chamber cover for connecting a water hose to a water chamber bottom plate of a water chamber of a directly water-cooled stator bar of an electric machine, comprising:
a peripheral groove which is open on a side facing away from the water chamber and is designed to hold the water hose.

2. The water chamber cover as claimed in claim 1,
wherein the peripheral groove has an inner wall and an outer wall, and the outer wall is designed to be pressed radially inward against the water hose and the inner wall in a water-tight manner.

3. The water chamber cover as claimed in claim 1 or 2, further comprising:
a cover body, and
a water hose connector, which is connected to the cover body in a form-fitting and water-tight manner and on which the peripheral groove is arranged.

4. The water chamber cover as claimed in claim 1, further comprising:
at least one bottom plate connecting element which is designed to be connected in a fitted state to the water chamber bottom plate in a form-fitting manner.

5. The water chamber cover as claimed in claim 4, comprising
a sealing element which is arranged on a contact surface of the water chamber cover and is designed, in a fitted state, to seal a bottom chamber connecting periphery of the water chamber cover and of the water chamber bottom plate against water escaping.

6. The water chamber cover as claimed in claim 3,
wherein the connection between the water hose connector and the cover body and/or the connection between the cover body and the water chamber bottom plate are/is formed by a screw connection, by a heat shrinkage connection or by brazing or by a weld seam.

7. A cooling circuit connection fitting, comprising:
at least one water hose, and
the water chamber cover as claimed in claim 1.

8. A method for assembling a cooling water circuit for a directly water-cooled stator bar, comprising:
inserting a water hose between an outer wall and an inner wall of a peripheral groove of a water chamber cover,
pressing the outer wall radially inward against the water hose and/or the inner wall in a water-tight manner.

9. The method as claimed in claim 8, wherein
a water hose connector and a cover body of the water chamber cover are connected to each other in a form-fitting and water-tight manner beforehand.

10. The method as claimed in claim 8, further comprising:
subsequently connecting a cooling circuit connection fitting formed by the water chamber cover and the hose to a water chamber bottom plate in a form-fitting and water-tight manner by a bottom plate connecting element.
